(19) United States
(12) Patent Application Publication
(10) Pub. No.: US 2008/0227430 A1
(43) Pub. Date: Sep. 18, 2008

(54) Adding Emergency Numbers to a Mobile Address Book

(76) Inventor: James M. Polk, Colleyville, TX (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/686,523

(22) Filed: Mar. 15, 2007

(51) Int. Cl. H04M 11/04

(52) U.S. Cl. 455/404.2; 455/404.1

(57) ABSTRACT

In one embodiment, a method and corresponding apparatus provide a user with emergency service information which is significant to the user's location. A user's address book is updated with emergency service information for at least one emergency service, the emergency service information is based on the user's location, and the emergency service information for the at least one emergency service is presented in a manner which indicates the significance of the emergency service information to the user's location.

### TECHNICAL FIELD

The present disclosure relates generally to emergency communications.

### BACKGROUND

Emergency services are not universal, but differ from location to location. In different locations, emergency services differ in the type of services provided. For example, in one location, a single emergency service provides general services. In another location, specific emergency services provide specific services, such as police, fire, ambulance, and mountain rescue. Additionally, in different locations, emergency services differ in how a user contacts or otherwise gains access to emergency services. For example, there are more than 60 different emergency service numbers in use around the world; some are one digit long, and some are seven digits long.

This lack of universality is compounded given a user's high degree of mobility. Oftentimes, a user knows emergency service information for an emergency service in one location, but not in another location. Consider the example of an American tourist traveling to France for vacation. Having grown up in the United States, the tourist knows to dial 911 in an event of an emergency. However, in France dialing 911 for emergency services does not work. In an event of an emergency, the tourist may not know whether is there a single emergency service number to dial, like in the United States, or separate emergency service numbers for police and fire. Knowing emergency service information for emergency services in the United States, while helpful for emergencies in the United States will not help the tourist in an event of an emergency in France.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A illustrates an example of a user being provided with locally significant emergency service information;

FIG. 1B illustrates an example of a user being provided with emergency service information for an emergency service which is significant to the user's location;

FIG. 1C illustrates an example of a user's address book being updated with emergency service information in an event the user changes from a first location to a second location;

FIG. 2A illustrates an example message flow of an example pull architecture;

FIG. 2B illustrates an example message flow of an example push architecture;

FIGS. 3A-3C illustrates example message flows of learning locally significant emergency service information using Dynamic Host Configuration Protocol (DHCP), Session Initiation Protocol (SIP), and Location-to-Service Translation (LoST) protocol;

FIGS. 4A and 4B illustrate example displays of presenting emergency service information in a manner which indicates the significance of the emergency service information to a user's location;

FIG. 5 illustrates an example process for providing locally significant emergency service information; and

FIG. 6 illustrates an example apparatus to provide locally significant emergency service information.

### DETAILED DESCRIPTION OF EXAMPLE EMBODIMENTS

With cellular and Internet Protocol (IP) technologies, it is possible to learn emergency service information for emergency services for a user's location. Even though emergency service information for an emergency service is learned, a user may not know to use such information in an event of an emergency. That is to say, there is a gap between what the user knows is emergency service information for an emergency service and what emergency service information is learned for the user's location.

One solution is to provide an “emergency button,” which a user depresses in an event of an emergency. This solution however creates the possibility of accidentally pressing the emergency button (e.g., in a purse or pocket) and placing a false emergency call.

With the present approach, a method provides emergency service information for an emergency service which is locally significant to the user's location. As such, the method updates a user's “contacts” address book (hereinafter as an address book) with emergency service information for at least one emergency service. The emergency service information is based on the user's location. The method also presents the emergency service information for the at least one emergency service in a manner which indicates the significance of the emergency service information to the user's location.

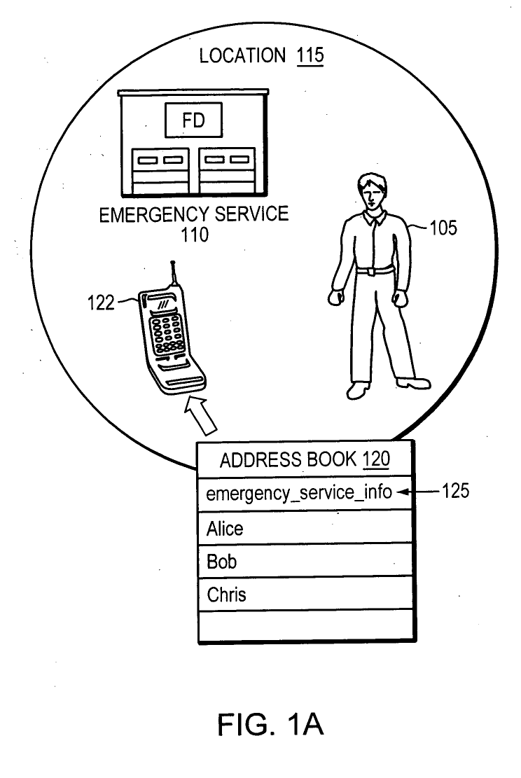

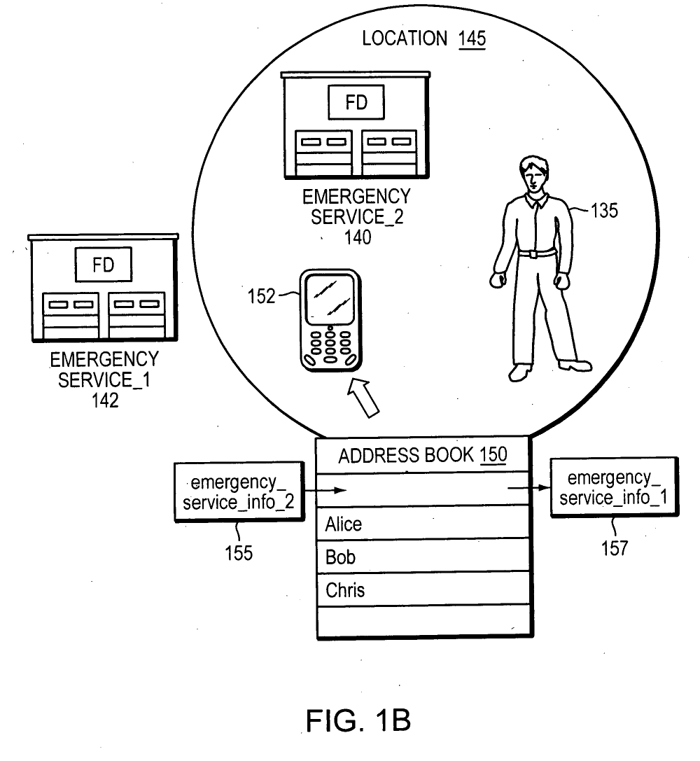

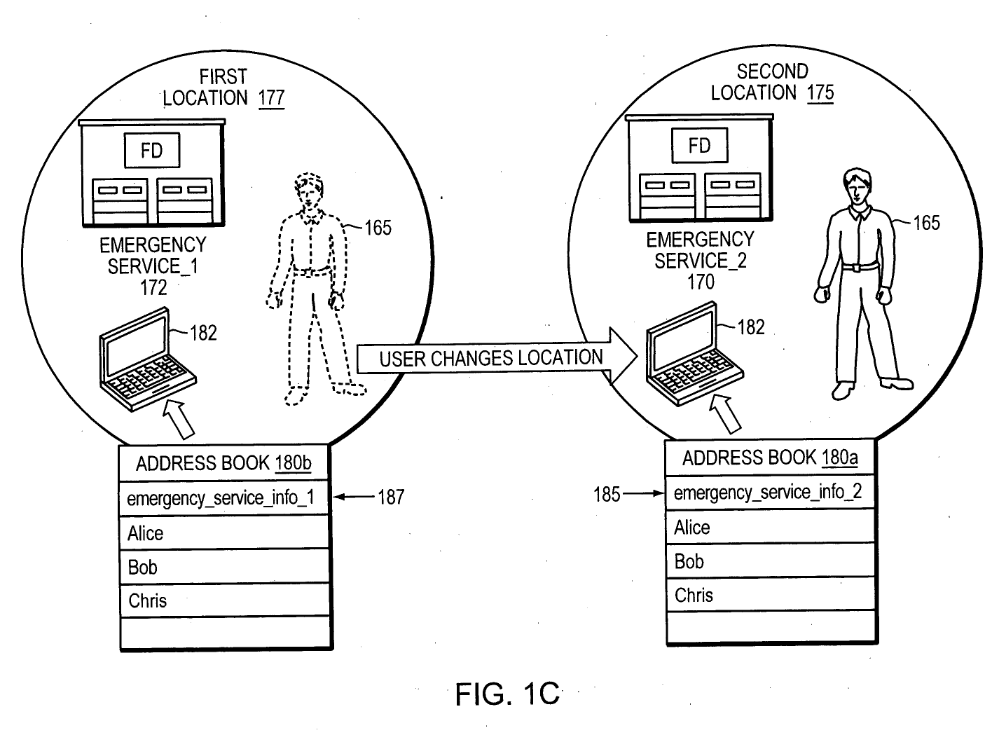

FIGS. 1A-1C illustrate examples of updating a user's address book with emergency service information for at least one emergency service based on the user's location.

FIG. 1A illustrates a user 105 and an emergency service 110 located in a location 115. The user's 105 address book 120 is updated with emergency service information 125 for the emergency service 110, in a manner described further herein. The address book 120 is not, however, updated with emergency service information of an emergency service not located in the location 115. In this way, the address book 120 is updated with the emergency service information 125 based on the location of the user 105. Because the user 105 and the emergency service 110 are both located in the location 115, in an event of an emergency, the emergency service 110 is likely in a position to aid or otherwise serve the user 105. In contrast, an emergency service not located in the location 115, is not likely to be in a position to serve the user 105.

Consider the following example of a user dialing for the police. In the United States, emergency service information for the police, such as an emergency dialstring, is 911. That is, a user dials 911 for the police in the United States. In France, on the other hand, the emergency service information for the police is not the emergency dialstring 911, but the dialstring 112. To a user in France, dialing 911 has no pertinence or significance to dialing for the local police. Likewise, to a user in the United States, dialing 112 has no significance to dialing for the local police. As such, emergency service information is said to be significant to a user's location or is otherwise locally significant.

FIG. 1B illustrates a user 135 located with a second emergency service 140 in a location 145. A first emergency service 142, however, is not located in the location 145. The user's 135 address book 150 is updated with emergency service information 155 for the second emergency service 140. Because the first emergency service 142 is not located in the location 145, the address book 150 is not updated with emergency service information 157 for the first emergency service 142. In this way, the address book 150 is updated by populating the address book 150 with the emergency service information 155 which is significant to the user's 135 location 145.

However, the user 135 may have at one time been located with the first emergency service 142. In such an instance, the emergency service information 157 for the first emergency service 142 was at one time significant to the user's 135 location. As such, the address book 150 may have been populated with the emergency service information 157. Because the user 135 is no longer located with the first emergency service 142, the emergency service information 157 is no longer significant to the user's 135 location 145. Accordingly, the emergency service information 157 for the first emergency service 142 is removed or otherwise de-populated from the address book 150. In this way, the address book 150 is updated by de-populating the address book 150 of the emergency service information 157 which is no longer significant to the user's 135 location 145.

Consider the following example of a user previously located in France, but now currently located in the United States. In France, the user's address book was populated with emergency service information for the French police. Now in the United States, the user's address book is depopulated of the emergency service information for the French police and populated with emergency service information for the American police. In this way, a user's address book is updated by populating the address book with emergency service information which is significant to the user's location, and depopulating the address book of emergency service information which is not significant to the user's location.

FIG. 1C illustrates a user 165 currently located with a second emergency service 170 in a second location 175. Because the user 165 is currently located with the second emergency service 170, the user's 165 current address book 180a includes emergency service information 185 for the second emergency service 170.

Previously, the user 165 was located (denoted by dashed lines) with a first emergency service 172 in a first location 177. Because the user 165 was previously located with the first emergency service 172, the user's 165 previous address book 180b included emergency service information 187 for the first emergency service 172.

In this way, the current address book 180a is updated from the previous address book 180b in an event the user 165 moves or otherwise there is a change from the first location 177 to the second location 175.

The first and second locations (175 and 177, respectively) include, but are not limited to, physical geographical areas, such as states and countries; and logical locations, such as a cell, local area network (LAN), virtual private network (VPN), 802.11 WiFi hotspot, and the like.

Furthermore, the first location 177 may not be a location at all. Consider the example of a user initializing or otherwise activating a communication device, such as a mobile phone, in a location. Prior to initializing, a location of the communication device is not yet known to the communication device. By initializing a communication device (e.g., by registering the communication device with a server), a location of the communication device and the user can be determined by well-known techniques. The user's address book is updated with emergency service information which is locally significant to the location where the user initialized. In this way, a user's address book can be updated with the emergency service information for at least one emergency service in an event the user is initialized in a location.

In some embodiments, the address books 120 (FIG. 1A), 150 (FIG. 1B), 180a and 180b (FIG. 1C) may be implemented in a communication device, such as a mobile phone, satellite phone, Internet phone, and a software-based phone application operating on a stationary (desktop) or mobile (laptop) computer (also known as a “soft phone”). Such a communication device is illustrated as an example cell phone 122 (FIG. 1A), an example personal digital assistant (PDA) 152 (FIG. 1B), and an example “soft phone” 182 (FIGS. 1B and 1A).

The communication device may provide one-way communication (e.g., communication from a service provider to the communication device) or two-way communication (e.g., communication to and from the service provider). Furthermore, the communication device may use any physical transmission medium, such as radio wave, microwave, and infrared; and any type of channel or resource access method, such as code division multiple access (CDMA), time division multiple access (TDMA), and Institute of Electrical and Electronics Engineers (IEEE) 802.11 (WiFi). Moreover, the communication device may employ one or more cellular technologies, such as Global System for Mobile Communications (GSM), General Packet Radio Service (GPRS), Universal Mobile Telecommunications System (UMTS), Code Division Multiple Access 2000 (CDMA2000); and other 2nd generation (2G), 2.5 generation (2.5G), and 3rd generation (3G) cellular technologies.

One skilled in the art will readily recognize the principles of the present invention do not depend on being implemented in a particular communication device, nor depend on a particular underlying cellular technology. As such, embodiments of the present invention are also applicable to future communication devices as well as future cellular technologies, such as upcoming 4th generation (4G) cellular technologies.

In embodiments where a user's address hook is implemented in a communication device, updating the address book with emergency service information includes updating the communication device with the emergency service information.

Emergency service information for emergency services may be stored or otherwise made available to a user or the user's communication device by an emergency service information repository or store. In some instances, the emergency service information store is located within the user's location, while in other instances the store is outside of the user's location. Furthermore, the emergency service information store may be centrally located in a single location or distributed to multiple locations.

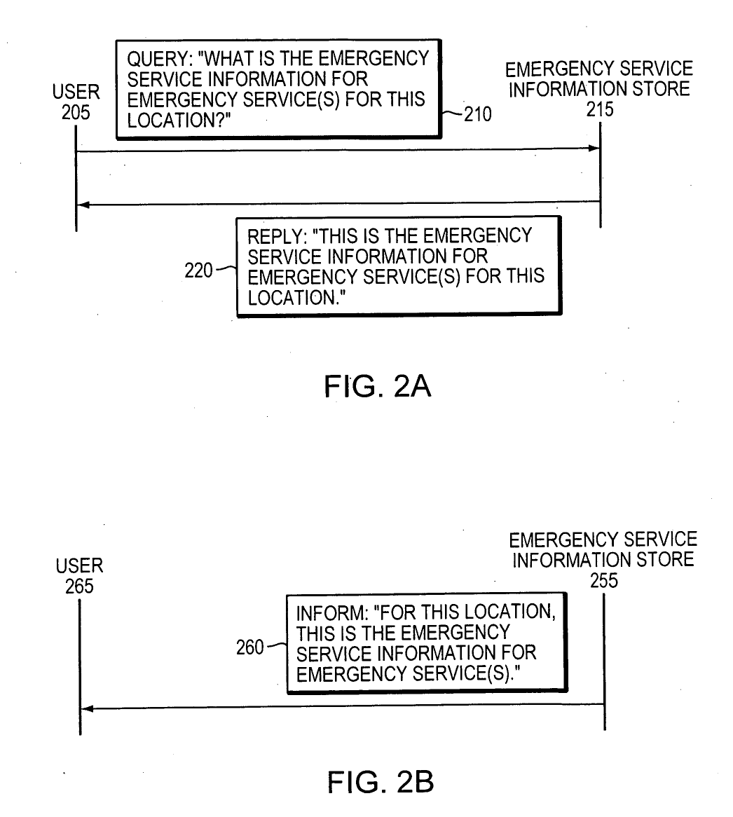

FIGS. 2A-2B illustrate examples of updating a user's address book by querying for or receiving emergency service information which is significant to the user's location.

In FIG. 2A a user 205, in a location, queries (210) for emergency service information for an emergency service in the location. In response, emergency service information store 215 replies (220) with emergency service information for the emergency service for the location. In this way, the user's 205 address book may be updated by querying for emergency services information which is significant to the user's 205 location.

The user 205 may query (210) and the emergency service information store 215 may reply (220) using a communication protocol, such as Internet Protocol (IP). Furthermore, the user 205 may query (210) and the emergency service information store 215 may reply (220) in a unicast (i.e., one-to-one), broadcasts (i.e., one-to-all), or multicast (i.e., one-to-some) manner, as is known in the art. Moreover, the user 205 may query (210) and receive a reply from the emergency service information store 215 using a communication device, such as a cell phone or IP phone.

Because the emergency service information is “pulled” by the user 205 from the emergency service information store 215, communication architecture illustrated in FIG. 2A may be referred to as “pull architecture.”

In FIG. 2B, an emergency service information store 255 informs (260) a user 265, in a location, of emergency service information for an emergency service for the location. In this way, the user's 265 address book may be updated by receiving emergency service information which is significant to the user's 265 location.

The emergency service information store 255 may inform (260) the user 265 using a communication protocol, such as Internet Protocol (IP). Furthermore, the emergency service information store 255 may inform (260) the user 265 in a unicast (i.e., one-to-one), broadcasts (i.e., one-to-all), or multicast (i.e., one-to-some) manner, as is known in the art. Moreover, the user 265 may receive emergency service information from the emergency service information store 255 using a communication device, such as a cell phone or IP phone.

Because the emergency service information is “pushed” from the emergency service information store 255 to the user 265, the communication architecture illustrated in FIG. 2B may be referred to as “push architecture.”

In some embodiments, a user's address book is updated with emergency service information acquired or otherwise learned by the user or by the user's communication device using a protocol, such as a protocol for the application layer of the Open Systems Interconnection (OSI) Basic Reference Model.

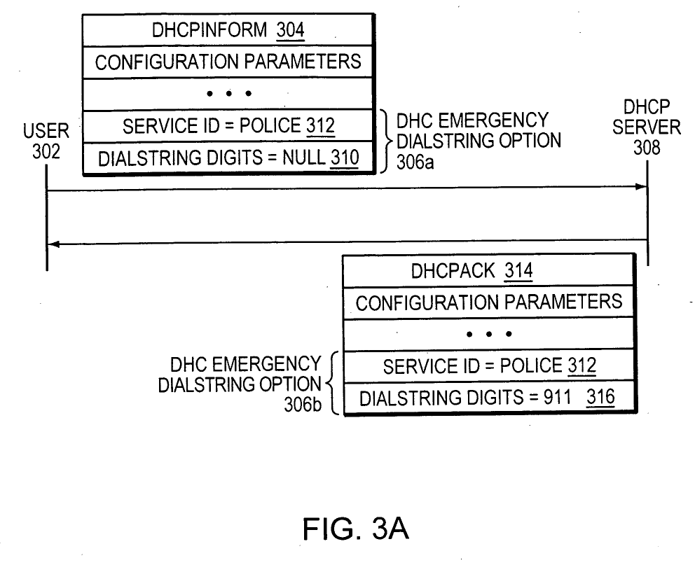

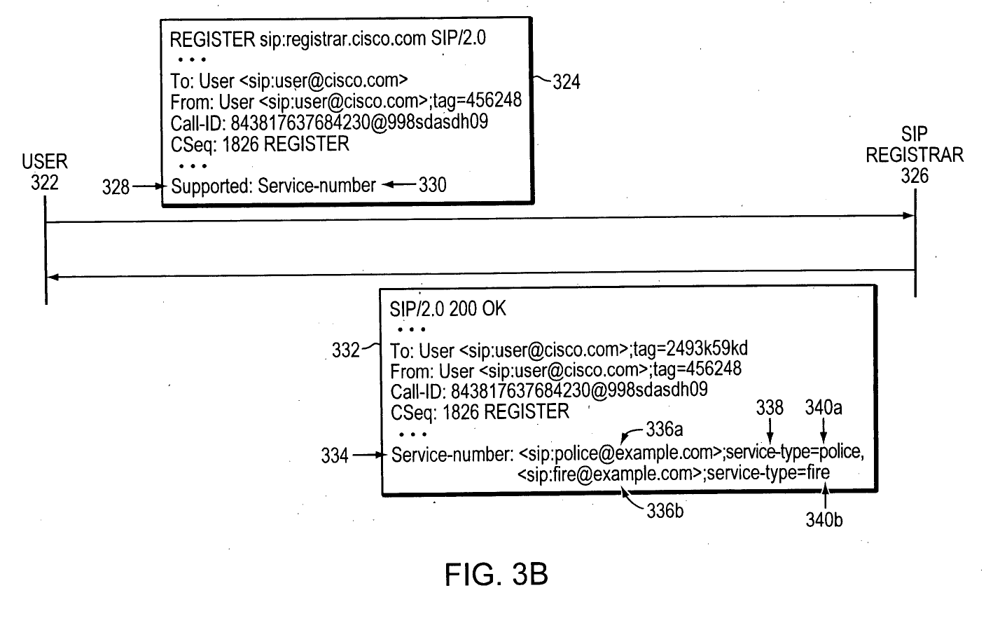

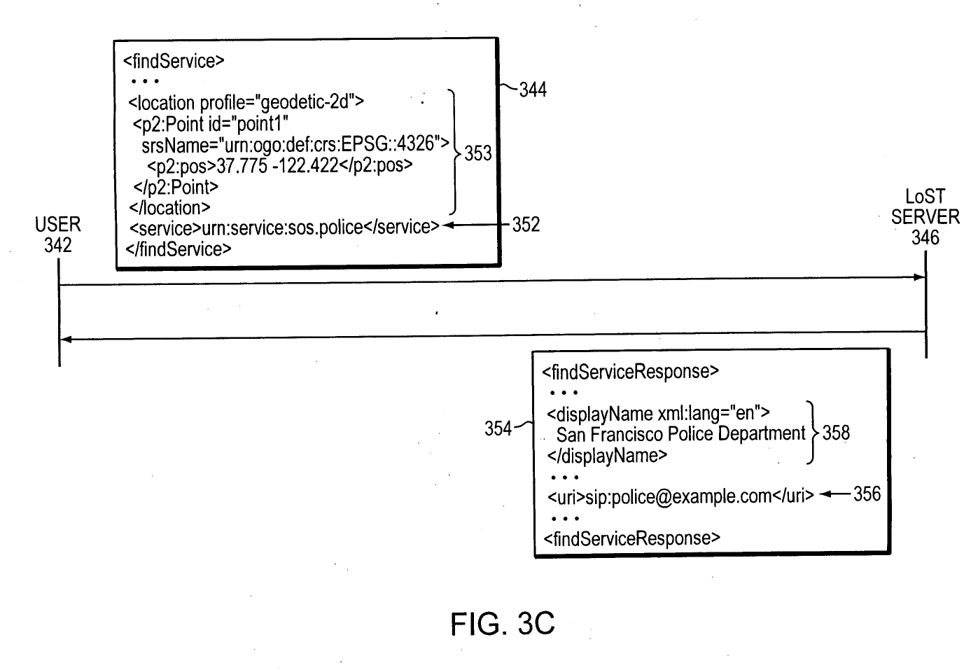

FIG. 3A illustrates acquiring or otherwise learning emergency service information for an emergency service for a user's location using the Dynamic Host Configuration Protocol (DHCP).

In general, DHCP provides configuration parameters to a host as standardized by Request for Comments (RFC) 2131, entitled, “Dynamic Host Configuration Protocol,” R. Droms, March 1997. DHCP is built on a client-server model, where designated DHCP server hosts deliver configuration parameters to dynamically configured hosts. In addition to configuration parameters, optional configuration parameters may be requested and provided to hosts through DHCP options, as standardized by RFC 2132, entitled, “DHCP Options and BOOTP Vendor Extensions,” S. Alexander and R. Droms, March 1997. One such option, the “Dynamic Host Configuration (DHC) Emergency Dialstring Option,” enables a client to request an emergency dialstring for an emergency service for the user's location (i.e., locally significant) from a local infrastructure, as proposed in draft-polk-dhc-emergency-dialstring-option-00.txt, entitled, “A Dynamic Host Configuration Protocol Option for the Locally Significant Emergency Calling Dialstring,” J. Polk and B. Rosen, February 2006.

Continuing with FIG. 3A, a user 302 sends, in a typical DHCP manner, a DHCPINFORM message 304 with a DHC Emergency Dialstring Option 306a to a DHCP server 308. The DHC Emergency Dialstring Option 306a requests emergency service information for an emergency service for the user's location (denoted by a NULL dialstring field value). In this example, the user 302 requests an emergency dialstring (Dialstring Digits) 310 and includes an emergency service identifier (Service ID) 312. The emergency service identifier 312 identifies the type of emergency service requested as police. That is, the user 302 wants to learn what emergency dialstring to dial for the police.

Alternatively, instead of sending a DHCPINFORM message, a user may request emergency service information for an emergency service for the user's location by sending a DHCPDISCOVER or DHCPREQUEST message. Similar to the above, the user sends, in a typical DHCP manner, the DHCPDISCOVER or DHCPREQUEST with a DHC Emergency Dialstring Option to a DHCP server, requesting emergency service information for an emergency service for the user's location.

Continuing with FIG. 3A, the user 302 receives, in a typical DHCP manner, a DHCPACK message 314 with a DHC Emergency Dialstring Option 306b from the DHCP server 308 The DHC Emergency Dialstring Option 306b provides emergency service information for the emergency service for the user's 302 location. In this example, the user 302 receives an emergency dialstring (Dialstring Digits) 316 for police service for the user's 302 location. That is, the user 302 learns what emergency dialstring to dial for the police given the user's 302 location.

The location of the user 302 may be known to the DHCP server 308 because the user 302 informs the DHCP server 308. For example, the user 302 sends a DHCPINFORM message with a country or location code identifying the location of the user 302, Alternatively, the DHCP server 308 may determine the location of the user 302 using RFC 3825) entitled, “Dynamic Host Configuration Protocol Option for Coordinate-based Location Configuration Information,” J. Polk et al., July 2004. The DHCP server 308 may also determine the location of the user 302 based on a DHCPINFORM message sent by the user 302 and knowledge of topology of a network and geography; or based on the fact the DHCP server 308 only serves the user's 302 location.

In another example, the DHCPINFORM message 304 may include a DHC Emergency Dialstring Option requesting emergency service information for more than one emergency service. In this way, the user 302 may learn emergency service information for one or more emergency services.

In yet another example, the DHCPINFORM message 304 may include a DHC Emergency Dial string Option requesting emergency service information for any emergency service. That is, the user 302 need not specifically request emergency service information for a particular type of emergency service. In this way, the user 302 may learn emergency service information for one or more emergency services.

FIG. 3B illustrates acquiring or otherwise learning emergency service information for an emergency service for a user's location using the Session Initiation Protocol (SIP). In general, SIP creates, modifies, and terminates sessions, such as Internet telephone calls, multimedia distribution, and multimedia conferences, with one or more participants, as standardized by Request for Comments (RFC) 3261, entitled, “Session Initiation Protocol,” J. Rosenberg, et al., June 2002.

Registration is one way in SIP for a server (e.g., a SIP registrar) to learn the current location of a user. In addition to conveying the current location of the user, emergency service information for an emergency service may be requested and provided during registration using one or more SIP option-tags and headers.

For example, a “Service-number” option-tag enables a user to request emergency service information, such as an emergency number, for an emergency service for the user's location. In response, a “Service-number” header containing emergency service information for one or more emergency services, which is locally significant to the user's location, is returned.

Continuing with FIG. 3B, a user 322 sends, in a typical SIP manner, a REGISTER message 324 to a SIP registrar 326. In the REGISTER message 324, a Supported header 328 includes a “Service-number” option-tag 330. In this way, the user 322 requests that the SIP registrar 326 provide emergency service information for emergency service(s) which is locally significant to the user's 322 location. That is, the user 322 wants to learn what emergency information, such as an emergency service address, to use given the user's 322 location.

The user 322 receives, in a typical SIP manner, a “200 OK” message 332 from the SIP registrar 326. In the “200 OK” message 332, a “Service-number” header 334 includes emergency service information for one or more emergency services. In the example illustrated in FIG. 3B, the “Service-number” header 334 includes emergency service addresses 336a and 336b for police and fire services, respectively.

The “Service-number” header 334 may also include a “service-type” header parameter 338 identifying the type of emergency service. In the example illustrated in FIG. 3B, the “service-type” header parameter 338 includes emergency service identifiers 340a and 340b identifying the type of emergency services as police and fire, respectively. That is, the user 322 learns what emergency service address to use for the police and what emergency service address to use for the fire department given the user's 322 location.

The location of the user 322 may be known to the SIP registrar 326 because the user 322 informs the SIP registrar 326 in a REGISTER message. Alternatively, the SIP registrar 326 may determine the user's 322 location based on the fact the SIP registrar 326 only serves the user's 322 location.

FIG. 3C illustrates acquiring or otherwise learning emergency service information for an emergency service for a user's location using the Location-to-Service Translation (LoST) protocol. In general, LoST maps a service identifier and location information to one or more service Universal Resource Locator (URL), as proposed by Internet-Draft draft-ietf-ecrit-lost-04.txt, entitled, “LoST: A Location-to-Service Translation Protocol,” T. Hardie, et al., February 2007.

A user 342 sends, in a typical LoST manner, a findService message 344 to a LoST server 346. The findService message 344 requests emergency service information for an emergency service for a location 353. In the example illustrated in FIG. 3C, the user 342 requests emergency service information for an emergency service having a Uniform Resource Name (URN) 352 identifying the emergency service as police. That is, the user 342 wants to learn of the emergency service having the URN 352, given the location 353.

The user 342 receives, in a typical LoST manner, a findServiceResponse message 354 from the LoST server 346. The findServiceResponse message 354 provides emergency service information for an emergency service for the location 353. In this example, the user 342 receives emergency service information for the police with a Uniform Resource Identifier (URI) 356 or a Uniform Resource Locator (URL) locating the police. That is, the user 342 learns the URI 356 of the emergency service having the URN 352, given the location 353.

In another example, the findService message 344 may include more than one URN 352, each identifying a different emergency service. In this way, the user 342 may learn emergency service information for one or more emergency services.

In yet another example, the findService message 344 may include the URN 352 identifying any emergency service. That is, the user 342 need not specifically request emergency service information for an emergency service having a URN identifying a particular emergency service. As such, the user 342 may receive emergency service information for an emergency service with any URI or URL. In this way, the user 342 may learn emergency service information for one or more emergency services.

As FIGS. 3A, 3B, and 3C illustrate, learning emergency service information for an emergency service includes, in some embodiments, learning an emergency service address, such as an Emergency Dialstring, Service-number, and URN. Additionally, learning emergency service information includes, in some embodiments, learning an emergency service identifier, such as a Service-ID, Service-type, URI, or URL.

The above is not intended to be an exhaustive list of emergency service information learned by a user (or by the user's communication device), but rather serves as an example. One skilled in the art will readily recognize that other information learned by the user (or communication device) is within the contemplation of various embodiments of the present invention.

For example, in FIG. 3C, the findServiceResponse message 354 provides other information corresponding to the emergency service requested. In this example, the user 342 receives a displayName 358. In some embodiments, the displayName 358 is presented to the user 342 (described in greater detail below).

In addition to learning emergency service information for an emergency service using any one of DHCP, SIP, or LoST protocol, a user may alternatively learn such information using any combination of the aforementioned protocols. Because there may be more than one way for the user to learn emergency service information, the user may learn a first emergency service information using a first protocol and learn at least one second emergency service information using a second protocol.

Consider the following example of a user learning emergency service information for police service using DHCP and LoST. Because LoST is suited for providing a Universal Resource Indicator (URI), the user uses LoST to learn the URI for the police (e.g., police@example.com). Because DHCP is suited for providing an emergency dialstring, the user uses DHCP to learn the emergency dialstring for the police (e.g., 911). As a result, the user may contact the police using either the URI, which was learned using LoST, or the emergency dialstring, which was learned using DHCP.

Accordingly, because there may be more than one way for a user to learn emergency service information, the user's address book may be updated with emergency service information for an emergency service learned using any one or combination of DHCP, SIP, and LoST protocol.

DHCP, SIP, and LoST protocol are provided merely as examples of ways emergency service information for emergency services may be learned. One skilled in the art will readily recognize that principles of the present invention are not limited to these examples, but contemplate other ways as well. For example, emergency service information may be learned using Short Message Service (SMS), Instant Messaging (IM), or other messaging techniques for the application layer of the OSI Network Reference Model. In such an example, a user sends and receives, in a typical SMS manner, SMS messages to and from an SMS server to learn emergency service information for emergency services for the user's location.

Moreover, embodiments of the present invention are not limited to emergency service information learned using application layer protocols, such as those previously mentioned, In one example, emergency service information may be learned using the Link Layer Discovery Protocol (LLDP), a link layer protocol (i.e., a protocol for the link layer of the OSI Basic Reference Model) which allows a network device to advertise the identity and capabilities of the network device on a local network. LLDP is standardized in the Institute of Electrical and Electronics Engineers (IEEE) standard 802.1AB-2005. In another example, emergency service information may be learned using CISCO Discovery Protocol (CDP), another link layer protocol developed by CISCO SYSTEMS which allows information to be shared between CISCO equipment. Again, the generality of the principles of the present invention are not lost in view of the aforementioned examples.

Even though a user's address book is updated with emergency service information for an emergency service (e.g., by learning the information), the user may nevertheless not know to use the information in an event of an emergency. For example, despite learning it is necessary to dial individually for police and fire services, in error, the user may use emergency service information for the fire service to contact the police service thinking the information applies to both. That is to say, there is a gap between what the user knows is emergency service information and what emergency service information is learned for the user's location. Accordingly, in some instances, providing emergency service information to the user includes presenting the information in a manner which indicates the significance of the emergency service information to the user's location.

One solution for presenting emergency service information in a manner indicating the significance of the information to a user's location is to create an “emergency button.” In event of an emergency, the user would use the emergency button to contact an emergency service. This solution, however, creates the likelihood of the emergency button being accidentally pressed (e.g., in a purse or pocket) and placing a false emergency call. Another solution, one which does not create this accidental calling issue, is to present the emergency service information before other entries of the user's address book without regard for an existing ordering.

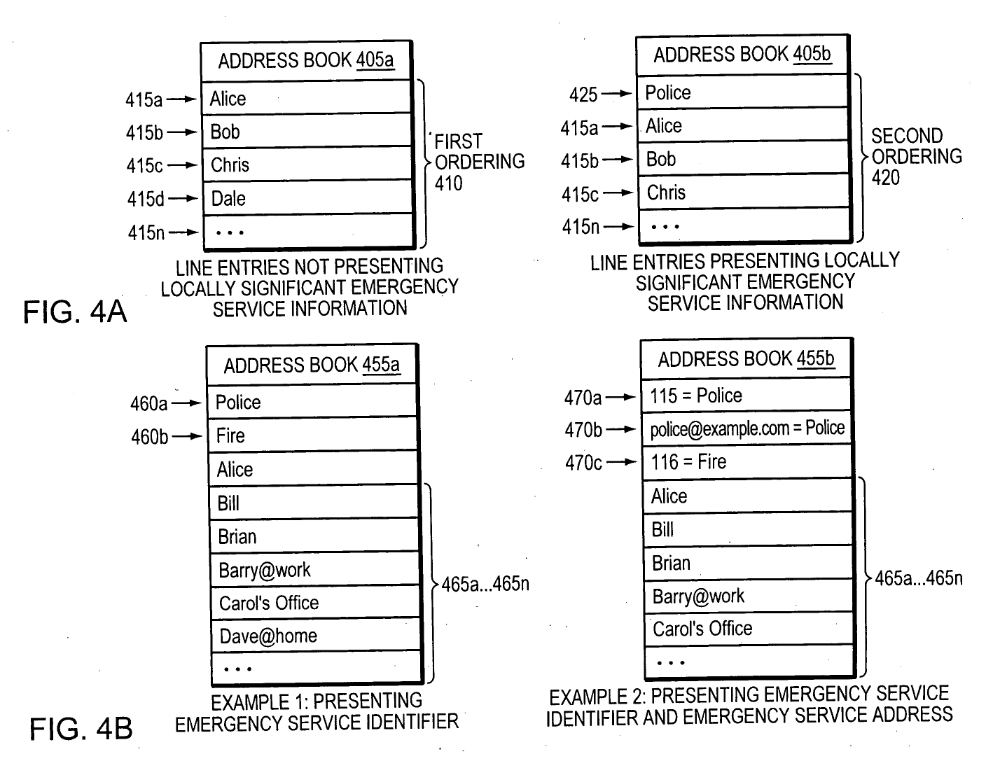

FIG. 4A illustrates an address book 405a with a first ordering 410 of line entries 415a, 415b . . . 415n, generally 415. In the example illustrated in FIG. 4A, in the first ordering 410, the line entries 415 are ordered alphabetically. In other examples (not shown) the line entries 415 may be ordered by stroke (e.g., for Chinese characters), by an order defined by a user, or by the order in which the entries 415 were entered into the address book 405a.

The address book 405a is updated with emergency service information (e.g., the emergency service information is learned using DHCP). The emergency service information is presented in an address book 405b with a second ordering 420. In the second ordering 420, the line entries 415 are preceded by an emergency service information line entry 425. In the example illustrated in FIG. 4A, despite the entry “police” coming after the entries “Alice, Bob, Chris . . . n” in the alphabet, the emergency service line entry 425 precedes the line entries 415. Presented differently, the first ordering 410 is superseded by the second ordering 420. In this way, emergency service information is presented by displaying the information as a line entry which precedes other line entries in a user's address book.

In reference to FIG. 4A, the second ordering 420 may be said to be an ordering which presents emergency service information which is significant to a user's location. In contrast, the first ordering 410 may be said to be an ordering which does not present emergency service information.

FIG. 4B illustrates, in a first example, presenting emergency service information for an emergency service includes presenting an emergency service identifier identifying the service. In this example, a first emergency service identifier 460a identifies police service and a second emergency service identifier 460b identifies fire service. Describe in reference to FIG. 4A, presenting emergency service information may include displaying the information as a line entry preceding other lines entries in a user's address book. Accordingly, in an address book 455a, the emergency service identifiers identifying police and fire services (460a and 460b, respectively) may be displayed as line entries preceding other line entries 465a, 465b . . . 465n, generally 465.

Recall, in reference to FIG. 3C, other information corresponding to an emergency service, such as the displayName 358, may be learned as well. As such, an emergency service identifier (not shown) identifying an emergency service as the New York Police Department (NYPD) may be displayed as the line entry preceding other line entries in the address book 455a. In this way, the presented emergency service information may not only identify a type of emergency service, but also which emergency service.

FIG. 4B illustrates, in a second example, presenting emergency service information further includes presenting emergency service addresses 470a, 470b, and 470c locating police and fire services. In this example, the emergency service address 470a locates the police using an emergency service dialstring. Also in this example, the emergency service address 470b locates the police using a Uniform Resource Identifier (URI). Because this embodiment presents both emergency service address and emergency service identifier, this may help a user learn and become familiar with emergency service addresses for emergency services.

In an address book 455b, similar to presenting the emergency service identifiers 460a and 460b, the emergency service addresses 470 may be displayed as line entries preceding other line entries 465.

In some instances, a single general emergency service address locates several emergency services. For example, in the United States, the emergency dialstring 911 locates a Public Safety Answer Point (PSAP). The PSAP is an agency, typically county or city controlled, responsible for answering 911 calls for emergency assistance for police, fire, and ambulance services. Accordingly, in these instances, presenting the emergency service address includes presenting any one or combination of an emergency dialstring or URI for a PSAP.

One skilled in the art will readily recognize that embodiments of the present invention are not limited to presenting emergency service information in a particular form. For example, in some instances, the emergency service information may be presented graphically. In such instances, presenting the emergency service information may depend on the capabilities of a user interface. In another example, the emergency service information may be presented textually. Again, in such instances, presenting the emergency service information may depend on the capabilities of the user interface. In yet another example, the emergency service information may be presented via an indicator, such as a key, button, visual prompt, or audio prompt. From the above, it should be clear that presenting emergency service information in a particular form is not significant.

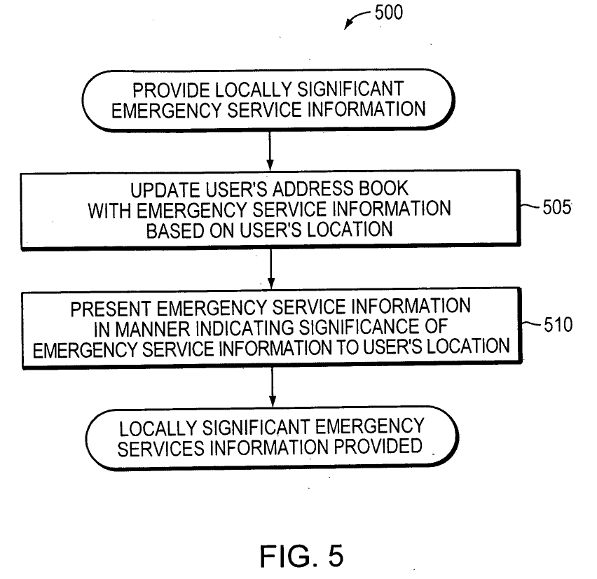

FIG. 5 illustrates an example process 500 for providing locally significant emergency service information. The process 500 starts to provide locally significant emergency service information. The process 500 updates (505) a user's address book with emergency service information for at least one emergency service. The emergency service information is based on the user's location. The process 500 presents (510) the emergency service information for the at least one emergency service in the user's address book in a manner which indicates the significance of the emergency service information for the user's location. The process 500 ends with the locally significant emergency service information provided.

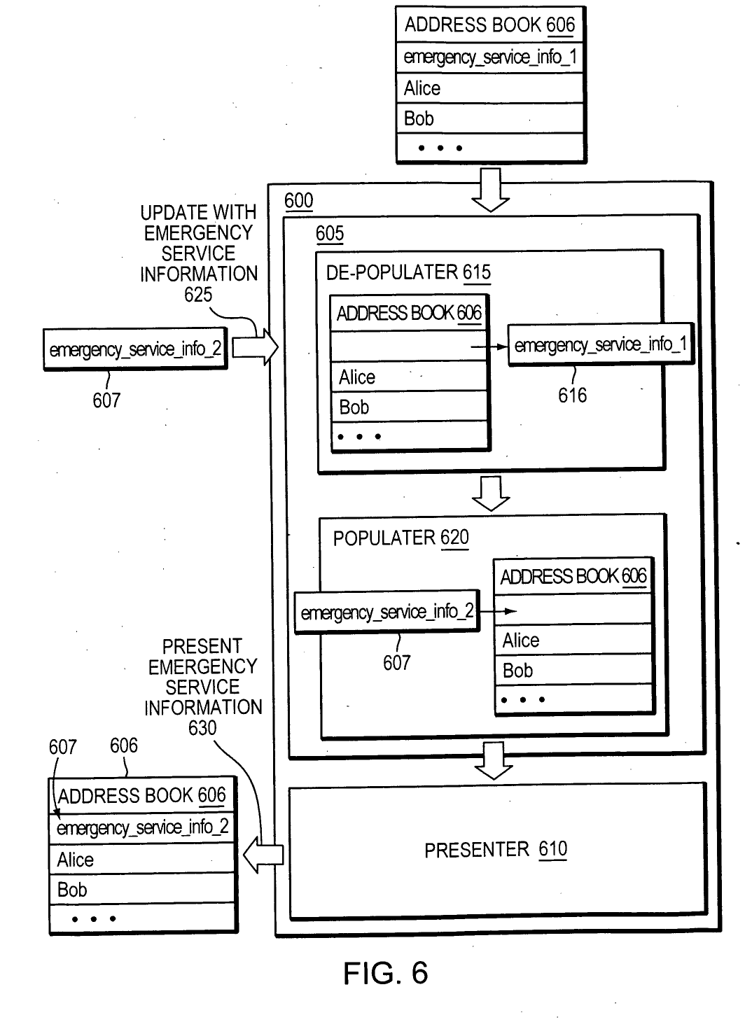

FIG. 6 illustrates an example apparatus 600 to provide locally significant emergency service information. The apparatus 600 includes an updater 605 to update a user's address book 606 with emergency service information 607 for at least one emergency service. The emergency service information 607 is based on the user's location. The apparatus 600 includes, coupled to the updater 605, a presenter 610 to present the emergency service information 607 for the at least one emergency service. The presenter 610 presents the emergency service information 607 in a manner which indicates the significance of the information 607 to the users location.

In an alternative embodiment illustrated in FIG. 6, the updater 605 further includes a de-populater 615 to de-populate the user's address book 606 of emergency service information 616 which is not significant to the user's location. The updater 605 also includes a populater 620 to populate the user's address book 606 with the emergency service information 607. The emergency service information 607, in contrast to the emergency service information 616, is significant to the user's location.

In summary, the apparatus 600 updates (625) the user's address book 606 with the emergency service information 607, and presents (630) the emergency service information 607.

While this invention has been particularly shown and described with references to example embodiments thereof, it will be understood by those skilled in the art that various changes in form and details may be made therein without departing from the scope of the invention encompassed by the appended claims.

It should be understood that elements of the block diagrams, network diagrams, and flow diagrams described above may be implemented in software, hardware, or firmware. For example, the updater 605 and the presenter 610 (FIG. 6) may be instantiated in a communication device, such as a mobile phone, which may or may not be part of PDA, a satellite phone, an Internet phone, and a software-based phone application operating on a stationary (desktop) or mobile (laptop) computer (also known as a “soft phone”).

In addition, the elements of the block diagrams and flow diagrams described above may be combined or divided in any manner in software, hardware, or firmware. If implemented in software, the software may be written in any language that can support the embodiments disclosed herein. The software may be stored on any form of computer-readable medium, such as RAM, ROM, CD-ROM, and so forth. In operation, a general purpose or application specific processor loads and executes the software in a manner well understood in the art.

Further, it should be understood that the flow diagram (e.g., FIG. 5) may include more or fewer blocks, be arranged differently, or be represented differently. It should be understood that implementation may define the flow diagram and number of flow diagrams illustrating execution of embodiments of the present invention.

What is claimed is:

1. A method comprising:
updating a user's address book with emergency service information for at least one emergency service, the emergency service information based on the user's location; and
presenting the emergency service information for the at least one emergency service in a manner which indicates the significance of the emergency service information to the user's location.

2. The method of claim 1 wherein updating the user's address book with the emergency service information includes:
depopulating the user's address book of emergency service information which is not significant to the user's location; and
populating the user's address book with emergency service information which is significant to the user's location.

3. The method of claim 1 wherein updating the user's address book includes querying for the emergency service information which is significant to the user's location.

4. The method of claim 1 wherein updating the user's address book includes receiving the emergency service information which is significant to the user's location.

5. The method of claim 1 wherein updating the user's address book includes learning the emergency service information which is significant to the user's location using any one or combination of: Dynamic Host Configuration Protocol (DHCP), Session Initiation Protocol (SIP), or Location to Service Translation (LoST) protocol.

6. The method of claim 1 wherein presenting the emergency service information includes presenting the emergency service information before other entries of the user's address book without regard for an existing ordering.

7. The method of claim 6 wherein presenting the emergency service information before other entries of the user's address book includes displaying the emergency service information as a line entry which precedes other line entries of the user's address book.

8. The method of claim 1 wherein presenting the one emergency service information includes presenting an emergency service information address and an emergency service identifier for the at least one emergency service.

9. The method of claim 8 wherein presenting the emergency service address for the at least one emergency service includes presenting any one or combination of an emergency dialstring or Uniform Resource Identifier (URI) for a Public Safety Answer Point (PSAP).

10. The method of claim 1 further comprising updating the user's address book with the emergency service information for the at least one emergency service in an event the user is initialized in the location.

11. The method of claim 1 further comprising updating the user's address book with the emergency service information for the at least one emergency service in an event the user changes locations.

12. The method of claim 1 wherein updating the user's address book the emergency service information includes updating the user's address book in a communication device selected from a group consisting of: a mobile phone, a satellite phone, an Internet phone, and a soft phone.

13. The method of claim 1 wherein presenting the emergency service information includes presenting the emergency service information using a user interface selected from a group consisting of: a graphic-based interface, a text-based interface, a visual indicator, and an audio indicator.

14. An apparatus comprising:
an updater to update a user's address book with emergency service information for at least one emergency service, the emergency service information based on user's location; and
a presenter coupled to the updater to present the emergency service information for the at least one emergency service in a manner which indicates the significance of the emergency service information to the user's location.

15. The apparatus of claim 14 wherein the updater includes:
a de-populater to depopulate the user's address book of emergency service information which is not significant to the user's location; and
a populater to populate the user's address book with emergency service information which is significant to the user's location.

16. The apparatus of claim 14 wherein the updater includes an interface to query for the emergency service information which is significant to the user's location.

17. The apparatus of claim 14 wherein the updater includes an interface to receive the emergency service information which is significant to the user's location.

18. The apparatus of claim 14 wherein the updater includes an interface to learn the emergency service information which is significant to the user's location using any one or combination of: Dynamic Host Configuration Protocol (DHCP), Session Initiation Protocol (SIP), or Location to Service Translation (LoST) protocol.

19. The apparatus of claim 14 wherein the presenter is configured to present the emergency service information before other entries of the user's address book without regard for an existing ordering.

20. The apparatus of claim 19 wherein the presenter is further configured to display the emergency service information as a line entry which precedes other line entries of the user's address book.

21. The apparatus of claim 14 wherein the presenter is configured to present the emergency service information as an emergency service address and an emergency service identifier for the at least one emergency service.

22. The apparatus of claim 21 wherein the presenter is further configured to present the emergency service address for the at least one emergency service as any one or combination of an emergency dialstring or Uniform Resource Identifier (URI) for a Public Safety Answer Point (PSAP).

23. The apparatus of claim 14 wherein the updater is further adapted to update the user's address book with the emergency service information for the at least one emergency service in an event the user is initialized in the location.

24. The apparatus of claim 14 wherein the updater is further adapted further to update the user's address book with the emergency service information for the at least one emergency service in an event the location of the user changes.

25. The apparatus of claim 14 wherein the updater and the presenter are instantiated in a communication device selected from a group consisting of a mobile phone, a satellite phone, an Internet phone, and a soft phone, the communication device having a user interface selected from a group consisting of: a graphic-based interface, a text-based interface, a visual indicator, and an audio indicator.

26. Logic encoded in one or more tangible media for execution and when executed operable to:
updating a user's address book with emergency service information for at least one emergency service, the emergency service information based on user's location; and
presenting the emergency service information for the at least one emergency service in a manner which indicates the significance of the emergency service information to the user's location.

27. An apparatus comprising:
means for updating a user's address book with emergency service information for at least one emergency service, the emergency service information based on the user's location; and
means for presenting the emergency service information for the at least one emergency service in a manner which indicates the significance of the emergency service information to the user's location.
